(19) United States
(12) Patent Application Publication
(10) Pub. No.: US 2020/0211093 A1
(43) Pub. Date: Jul. 2, 2020

(54) Process and system for finding cooking recipes and cooking ingredients

(71) Applicant: Zarina Salienko, Grand Prairie, TX (US)

(72) Inventor: Zarina Salienko, Grand Prairie, TX (US)

(21) Appl. No.: 16/236,651

(22) Filed: Dec. 31, 2018

(51) Int. Cl. G06Q 30/06; G06Q 30/02

(52) U.S. Cl. CPC G06Q 30/0639; G06Q 30/0282; G06Q 30/0238; G06Q 30/0641; G06Q 30/0623

(57) ABSTRACT

A system and computer recipe application that will allow a user to store and provide meals with an unlimited meal plans and ideas. It will use GPS Technology and will find the best stores near users. A user enters their location and the app finds the closest store to the user that stocks the ingredients they need. The application will have a store rating, detailed instructions on how to arrive, as well as discount coupons off a user's shopping list.

### CROSS-REFERENCES TO RELATED APPLICATIONS (IF ANY)

None

### BACKGROUND

### 1. Field of the Invention

The present invention relates to a process and application to locate and choose a recipe and location of the ingredients for that recipe.

### 2. Description of Prior Art

People find it hard to cook after a long day at work, or chasing the children around. Somehow, the chores keep piling up and never seem to end. The last thing people want when their tired and beat is to create a meal plan the whole family will love.

There is still room for improvement in the art.

### SUMMARY OF THE INVENTION

The current invention is a computer application (app) that is a recipe app makes use of GPS technology. A user enters their location and the app finds the closest store to the user that stocks the ingredients they need. The application will have a store rating, detailed instructions on how to arrive, as well as discount coupons off a user's shopping list.

The application will store and provide meals with an unlimited meal plans and ideas. It will use GPS Technology and will find the best stores near users. It will be a time saver as it allows a user to plan their meals, their ingredients and where to buy them.

The system, in the preferred embodiment, would work like a smartphone application, this product would be available through the respective marketplace for smartphones.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows a sample recipe page;

FIG. 4 shows a sample home screen;

FIG. 5 shows a sample social screen;

FIG. 6 shows a sample ingredient screen;

FIG. 7 shows a stores near me screen; and

FIG. 8 shows a grocery list screen.

### DESCRIPTION OF THE PREFERRED EMBODIMENT

There are a number of significant design features and improvements incorporated within the invention.

The current invention is an computer application (app)1 that is a recipe app makes use of GPS technology. A user enters their location and the app finds the closest store to the user that stocks the ingredients they need. The application will have a store rating, detailed instructions on how to arrive, as well as discount coupons off a user's shopping list.

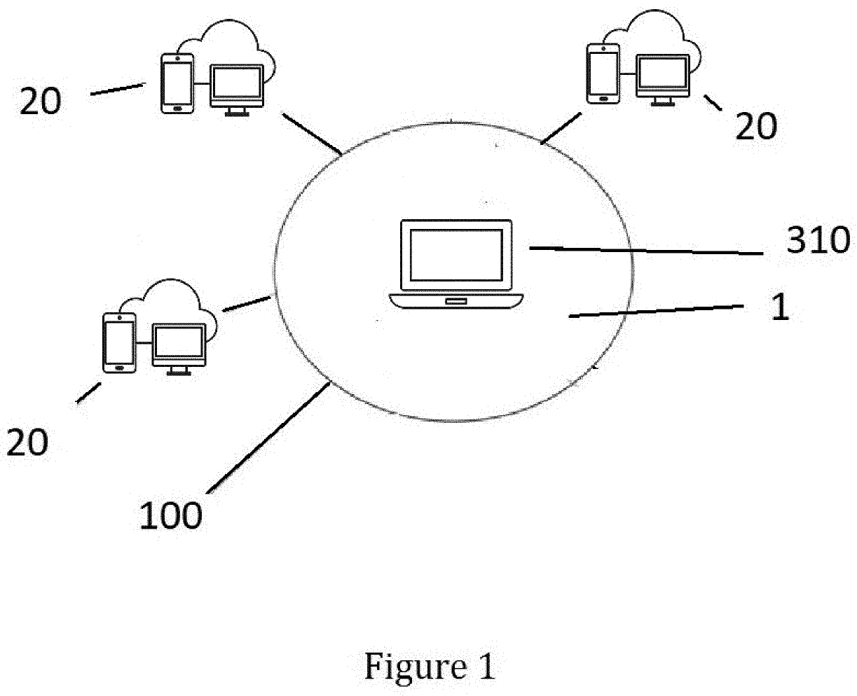

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 20 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 20 or smartphone communicating with others within the system 1.

The system 1, data and processing code can reside in the non-transitory memory 310 of the one or more computing devices. The system 1 in the preferred embodiment would be written to act like a smart phone application (app).

The current invention is an computer application (app) is a recipe app makes use of GPS technology. A user enters their location and the app finds the closest store to the user that stocks the ingredients they need. The users will see a store rating, detailed instructions on how to arrive, as well as discount coupons off their shopping list. The user can save their favorite recipes and search for new ideas.

The system 1 will allow a user to have creative meals as it is a handy recipe app with unlimited meal plan ideas. The system 1 uses GPS Technology which allows a user to find the best stores near them. It will provide time saving as it will allow a user to plan their meals, ingredients and to buy them. It will provide discount store coupons that let a user save money on their meals.

### Brief Overview

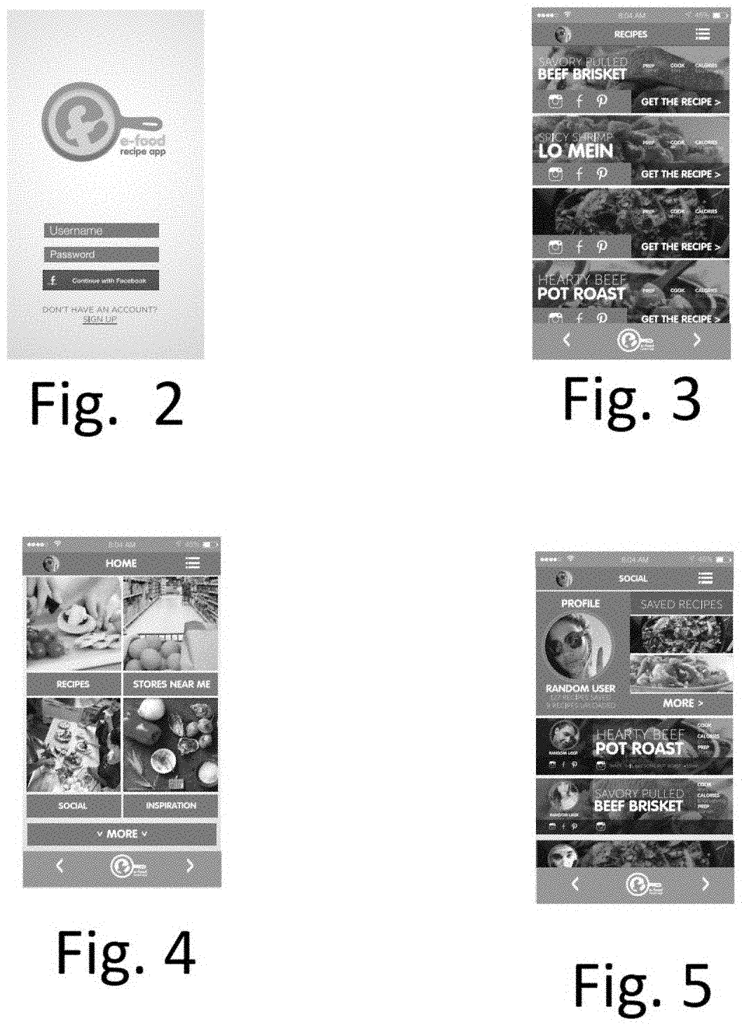

To use the system 1, users would sign-in directly or using social logins as shown in FIG. 2 with the user registering the app.

The system 1 will have a recipe page that displays the recipes where a user can choose a recipe to make. In the preferred embodiment, the recipe page will display a picture of the food made with the recipe. The user can input new recipes.

The system 1 will have a home page as shown in FIG. 4. The home page will connect the user to the functions and options of the system such as recipes, stores near me, social and inspiration.

The system 1 has a social screen as shown in FIG. 5. The social screen has a link to a user profile and saved recipes.

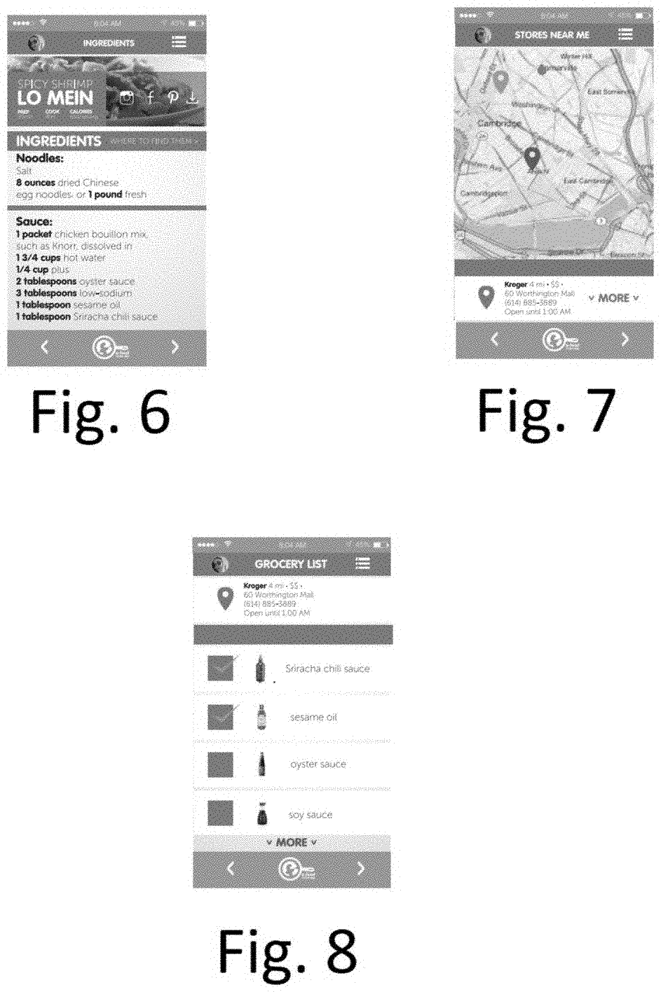

The system 1 will have an ingredients page for each recipe that will show the ingredients needed as shown in FIG. 6. The system 1 will have a near me function which will have a map and allow a user to search for local stores that will have the ingredients for sell as shown in FIG. 7. The application will have a store rating, detailed instructions on how to arrive, as well as discount coupons off a user's shopping list. The system 1 will put together a shopping list based on the chosen recipe as shown in FIG. 8.

### Advantages

The current invention has The current invention is an computer application (app) is a recipe app makes use of GPS technology. A user enters their location and the app finds the closest store to the user that stocks the ingredients they need. A user will see a store rating, detailed instructions on how to arrive, as well as discount coupons off their shopping list. The system will save favorite recipes and search for new ideas.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system for food preparation comprising;
having a system that resides in the non-transitory memory of a computing device;
providing recipes to be made;
providing ingredients for the recipes; and
locating stores that can provide the ingredients.

2. A system according to claim 1 having a home screen.

3. A system according to claim 1 having a recipe screen.

4. A system according to claim 1 providing coupons.

5. A system according to claim 1 allowing the entry of recipes.

6. A system according to claim 1 providing directions to the stores.

7. A system according to claim 1 providing ratings for the stores.
